(19) United States
(12) Patent Application Publication
(10) Pub. No.: US 2018/0126860 A1
(43) Pub. Date: May 10, 2018

(54) ADAPTIVE CHARGING STATION FOR AN ELECTRIC VEHICLE

(71) Applicant: Faraday&Future Inc., Gardena, CA (US)

(72) Inventor: Phillip John Weicker, Los Angeles, CA (US)

(21) Appl. No.: 15/623,330

(22) Filed: Jun. 14, 2017

Related U.S. Application Data
(60) Provisional application No. 62/350,063, filed on Jun. 14, 2016.

(51) Int. Cl. B60L 11/18; H02J 7/00

(52) U.S. Cl. CPC B60L 11/1844; H02J 7/008; B60L 11/1848

(57) ABSTRACT

Systems and methods for adaptive charging of electric vehicles are disclosed. Systems can include a charging station configured to draw current from an electrical supply circuit, a current detector in communication with the charging station and configured to measure a current through the electrical supply circuit, and processing circuitry configured to determine a charging current available to an electric vehicle based at least in part on the current measured by the current detector. The charging current available may be adjusted during a continuous charging session based at least in part on the monitored current.

### CROSS-REFERENCE TO RELATED APPLICATIONS

This application claims the benefit of U.S. Provisional Application No. 62/350,063, filed Jun. 14, 2016, the entirety of which is hereby incorporated by reference.

### FIELD

The systems and methods disclosed herein are directed to electric vehicle charging and, more particularly, to adjustable ampacity charging.

### BACKGROUND

Plug-in electric vehicles (PEVs), including plug-in hybrids and all-electric vehicles, can be propelled by one or more electric motors using electrical energy stored in one or more rechargeable batteries or another energy storage device. A charger or charging connector at a charging station may be plugged in to a charge port located on the vehicle to charge the vehicle's power source. Charging stations may be located at the home or workplace of a PEV owner, or in other locations accessible to the public. Charging stations may obtain power from conventional low voltage power sources or from higher voltage sources.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In one embodiment, an adaptive charging system for an electric vehicle is described. The system may include a charging station configured to draw current from an electrical supply circuit, a current detector in communication with the charging station and configured to measure a current through the electrical supply circuit, and processing circuitry configured to determine a charging current available to the vehicle based at least in part on the current measured by the current detector.

The system may further include communication circuitry configured to send information indicative of the available charging current to a vehicle couple to the charging station. The current detector may be further configured to measure the current through the electrical supply circuit repeatedly at regular intervals, and the processing circuitry may be further configured to determine the available charging current based at least in part on a plurality of current measurements. The communication circuitry may be configured to send information indicative of at least two different available charging currents to the vehicle coupled to the charging station during a continuous charging session. The electrical supply circuit may include a main breaker having a rated current, and the maximum charging current available may be less than the rated current. The maximum charging current available may be offset from the rated current by a safety limit. The charging current available may change based at least in part on one or more currents measured by the current detector. The charging current available may change based at least in part on a time of day.

In another embodiment, a method of charging one or more electric vehicle batteries with a charging station coupled to an electrical supply circuit is described. The method may include monitoring current through the electrical supply circuit, determining an amount of current available to the vehicle based at least in part on the monitored current, and limiting charging current to the vehicle based at least in part on the amount of current available.

The method may further include sending information indicative of the amount of current available to the vehicle. Monitoring current may include monitoring with one or more current detectors. The amount of current available may change during a continuous charging session. The electrical supply circuit may include a main breaker having a rated current, and the maximum amount of current available may be less than the rated current. Determining an amount of current available to the vehicle may be based at least in part on the monitored current and the rated current. Determining an amount of current available to the vehicle may be based at least in part on the monitored current, the rated current, and a safety limit. The amount of current available to the vehicle may be based at least in part on one or more previously monitored currents. The amount of current available to the vehicle may be based at least in part on the time of day.

In another embodiment, a method of charging one or more batteries of an electric vehicle is described. The method may include providing a first charging current to a vehicle from a vehicle charging station connected to an electrical supply circuit, monitoring the current drawn by the electrical supply circuit, and adjusting the first charging current based at least in part on the monitored current. Adjusting the first charging current may include sending a signal indicative of an allowable charging current to the vehicle. The first charging current may be adjusted in response to a change in the current drawn by the electrical supply circuit.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a schematic illustration of a PEV charging system including an adaptive charging station in accordance with an exemplary embodiment.

FIG. 2 is a flow chart illustrating an example method of adaptive charging in accordance with an exemplary embodiment.

FIG. 3A is a graph illustrating an allowable charging current determined based on a detected current in accordance with an exemplary embodiment.

FIG. 3B is a graph illustrating a time-dependent allowable charging current in accordance with an exemplary embodiment.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways. The described implementations may be implemented for charging applications in any electricity distribution system. While the systems and methods disclosed herein are described in the context of electric vehicle charging, they may also be implemented in other applications, such as powering HVAC systems, heavy equipment, or any other system configured to utilize electric power.

Plug-in electric vehicles (PEVs) may be charged in a variety of locations, such as homes, businesses, or public locations. Typically, PEVs may be charged at charging stations, also known as Electric Vehicle Supply Equipment (EVSE) units. Some public locations, such as parking lots, may have a limited number of EVSE units available for use with any compatible PEV. In addition, high speed charging stations may be available in various locations. However, many PEV owners prefer the convenience of charging their vehicles at home. EVSE units may be installed in residential locations, and may be connected to a home's existing electrical supply circuit to provide electricity to the PEV. Typically, a home EVSE unit may communicate with a charger located within the PEV using a control signal sent through a charging connector. For example, the EVSE unit may communicate an allowable charging current that is available for charging the PEV. Upon receiving an allowable charging current, the charger of the PEV may begin drawing current from the charging connector at or below the allowable charging current.

The charging rate (e.g., maximum current or power available) of a home EVSE unit may be limited due to the configuration of an electricity distribution system such as a distribution board. To avoid tripping a main breaker in the event of an overcurrent, home EVSE units are typically installed on a subsidiary circuit within a home electrical system. For example, a PEV and EVSE may be connected to a subsidiary circuit with a rated current of 30 Å in a distribution board having a main breaker rated at a much higher current, such as 60A. The EVSE would only be able to draw a current of up to 30 Å for charging the PEV, even when the other subsidiary circuits are drawing little additional current (e.g., at night). As described in greater detail below, an adaptive charging system capable of charging a PEV at a variable rate may allow a PEV to be charged at a higher rate during times of low power usage to reduce charging times.

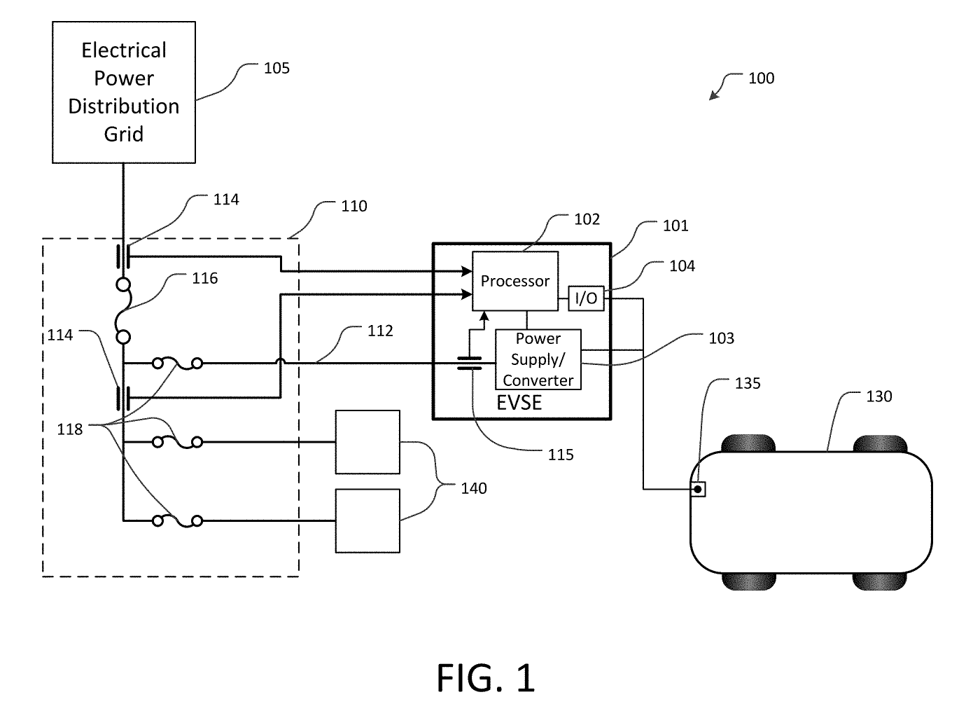

FIG. 1 is a schematic illustration of a PEV charging system 100 including an adaptive EVSE 101. The charging system 100 may draw power from a public utility source, such as a power distribution grid 105 or other suitable electricity source. Electric current from the grid 105 may travel to an electrical supply circuit 110, which can be connected to the EVSE 101. The EVSE 101 may draw power from the electrical supply circuit 110 through a primary electrical connection 112. The EVSE 101 may include a processor 102 configured to monitor currents detected by any of current sensors 114 and 115, determine allowable charging currents, or perform any other processing tasks related to control of vehicle charging. The EVSE 101 may further include a power supply/converter 103 configured to draw power from the electrical supply circuit 110 and provide charging current to the PEV 130, and an input/output unit 104 configured for communication between the processor 102 and the PEV 130. An internal current sensor 115 of the EVSE 101 may measure the current drawn by the EVSE 101 from the electrical supply circuit 110.

The EVSE 101 may be connected to a current sensor 114 configured to measure a current within the electrical supply circuit 110. For example the current sensor 114 may be configured to measure the total current drawn by the electrical supply circuit 110, or to measure the current drawn by only a portion of the electrical supply circuit 110 (e.g., the current drawn by all subsidiary circuits other than the subsidiary circuit containing the EVSE 101). In some embodiments, the EVSE 101 may use multiple current sensors 114 to monitor the current at a plurality of locations within or near the electrical supply circuit 110. A PEV 130 may connect to the adaptive EVSE 101 through charging connector 135 for communication and charging. In some embodiments, the electrical supply circuit 110 may be configured to provide power to one or more additional loads 140, such as other household appliances, through additional subsidiary circuits. The EVSE 101 may be configured to use feedback from the current sensor 114 to safely maximize and/or increase the charging current drawn by the PEV and decrease the time required to charge the PEV.

The electrical supply circuit 110 may be any circuit configured to receive electrical power either directly or indirectly from a power source such as a public utility power grid 105, and provide power to one or more subsidiary circuits. In various embodiments, the electrical supply circuit 110 may include one or more of a distribution board, electric panel, consumer unit, circuit breaker box, breaker panel, load center, or the like. For example, the electrical supply circuit 110 may be a breaker panel installed in a residence, public charging station, workplace, or other public or commercial location. In some embodiments, the electrical supply circuit 110 may be configured to provide power through any number of subsidiary circuits to all or a portion of a building, such as a house, apartment building, or office building. The electrical supply circuit 110 may include a main switch or breaker 116 configured to control the maximum current to the entire circuit 110. For example, the main breaker 116 may have a rated current in the range of 60 Å, 120 Å, 240 Å, or other suitable current rating. The electrical supply circuit 110 may further include one or more fuses or circuit breakers 118 within the subsidiary circuits. The circuit breakers 118 within the subsidiary circuits can control the maximum current within each subsidiary circuit.

The current sensor 114 can be located within the electrical supply circuit 110, such as a distribution board, or may be located elsewhere along the transmission path between the power grid 105 and the electrical supply circuit 110. In some embodiments, the current sensor 114 may be an ammeter or current shunt connected electrically to the supply circuit 110. The current sensor 114 may include circuitry, for example, a processor, memory, and/or other circuitry. In some embodiments, the current sensor 114 may not be electrically connected to the supply circuit 110. For example, the current sensor 114 may be a Hall effect current sensor, clamp meter, transformer, Rogowski coil, fiber optic current sensor, or any other type of current sensor. The current sensor 114 may be configured to continuously and/or repeatedly monitor the total current flowing to and/or from the electrical supply circuit 110 through the main breaker 116. For example, the current sensor 114 may measure the current at regular, repeated intervals, such as every ¼ second, ½ second, second, 5 seconds, 10 seconds, or other suitable measurement interval. In some embodiments, the current sensor 114 may be configured to measure the current constantly (e.g., obtaining a current measurement repeatedly at the maximum clock rate of a processor or other circuitry of the current sensor). The current sensor 114 may be configured to take measurements only when a PEV 130 is connected to the EVSE 101 for charging, or may be configured to take measurements continuously regardless of whether a PEV 130 is connected. Current measurements may be stored at the sensor 114 and/or may be transmitted to processing and/or memory circuitry (not shown) of the EVSE 101 for storage and/or analysis. The current sensor 114 may communicate with the EVSE 101 wirelessly or through a wired connection.

Current data received at the EVSE 101 from the current sensor 114 may be stored and may be analyzed to determine an allowable charging current. As described in greater detail below, the processing circuitry of the EVSE may determine an allowable charging current based at least in part on the present or past current measurements and the known rated current of the main breaker 116. The allowable charging current may be adjustable based on the amount of current being drawn by additional loads 140 or based on other criteria. In some embodiments, the allowable charging current may vary between OA and the full rated current of the main breaker 116, and can vary during the course of a single charging session. When charging of a PEV 130 is desired, during charging, and/or when the allowable charging current changes during a charging session, the EVSE 101 can communicate the allowable charging current to the PEV 130 through charging connector 135.

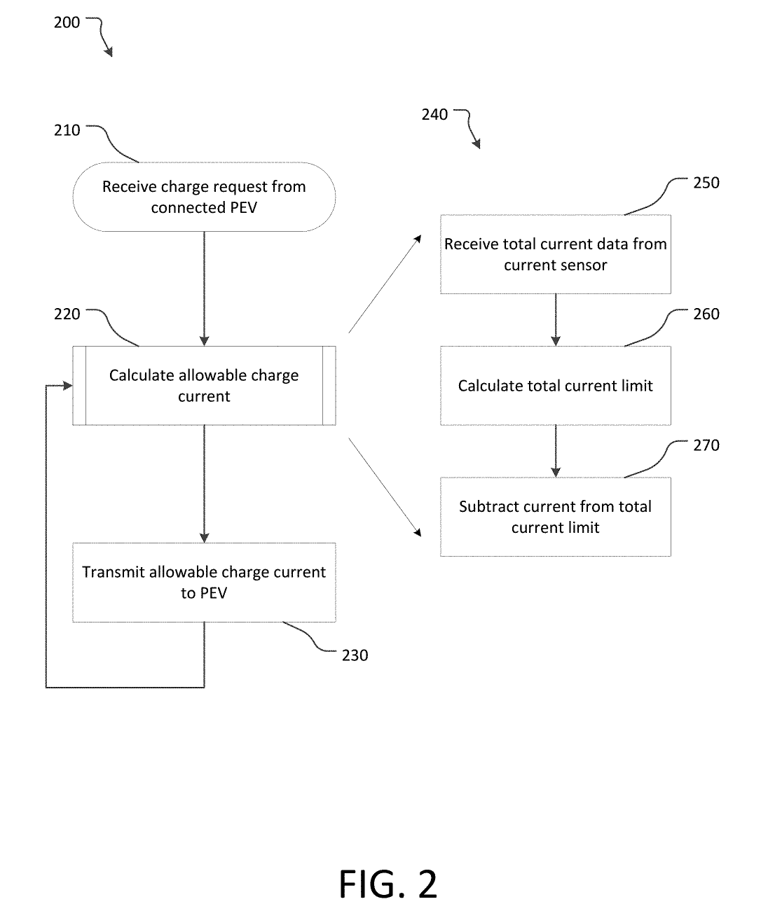

FIG. 2 depicts an example adaptive charging method 200 that may be implemented with a system such as the system described above with reference to FIG. 1. The process 200 may begin at block 210, where a charge request is received at an EVSE unit from a connected PEV. The charge request may be delivered through a charging connector as described above, or may be delivered through a communication means separate from the charging connector. In some embodiments, the charge request may be delivered by a PEV charging protocol, such as the J1772 standard, or other suitable signaling standard. The charge request may be initiated manually by a PEV user, such as the owner of the PEV, after positioning the PEV near the EVSE and connecting the charging connector. In some instances, the charge request may be initiated automatically, such as by an automatic scheduled charging program of the PEV configured to initiate charging at a set time or after a time delay. In some embodiments, such as where the J1772 standard is used, a charge request signal may include information indicating to the EVSE that the PEV is securely connected to the charging connector, and that charging may be authorized safely. After the charging request is received from the PEV, the method may continue to block 220.

At block 220, the EVSE may determine an allowable charging current. An allowable charging current can be a current magnitude the PEV is permitted to draw from the EVSE. In some embodiments, an allowable charging current may be determined so as to permit the PEV to charge its battery or batteries at a low risk of creating an overcurrent condition at the main breaker (e.g., a current in excess of the rated current of the main breaker). Methods for determining and/or calculating an allowable charging current will be discussed in greater detail below. Once an allowable charging current is calculated, the method may continue to block 230.

At block 230, the EVSE transmits the allowable charging current to the PEV. The allowable charging current may be transmitted to the PEV by any communication method, such as the methods described above for transmission of the charge request. Upon receiving the allowable charging current, the PEV may initiate charging by drawing a current less than or equal to the allowable charging current from the charging connector. The method may then return to block 220, either immediately, or after a time delay, to recalculate the allowable charging current. For example, the EVSE may be configured to recalculate the allowable charging current constantly, or every ¼ second, ½ second, second, two seconds, or other suitable frequency during charging.

In some embodiments, the EVSE may be configured to calculate an initial allowable charging current, and to recalculate the allowable charging current in response to a change in the measured current at the current detector or other change in input. The EVSE may thus be able to change the allowable charging current during a continuous charging session. A continuous charging session may include a charging session during which a charging connector is connected to a PEV and not unplugged. Thus, the systems and methods described herein may provide the advantageous capability of increasing or decreasing an allowable charging current without terminating a charging session, disconnecting a connected PEV, requiring user intervention, or otherwise interrupting the PEV charging process.

Referring now to subprocess 240, example methods of calculating an allowable charging current will be described. Subprocess 240 may be repeated entirely or in part any time the method 200 returns to block 220 to recalculate the allowable charging current. Subprocess 240 may begin at block 250 where current data is received from the current sensor. If the PEV is not charging when subprocess 240 is executed, the current measured at the current sensor can indicate the total current drawn by all other loads connected to the electricity distribution circuit, such as other household appliances drawing power from other subsidiary circuits. If the PEV is charging when subprocess 240 is executed, the current measured at the current sensor can include the charging current. The total current drawn by all other loads connected to the electricity distribution circuit may be calculated by subtracting the known charging current from the current measured at the current sensor. In some embodiments, a current detector may be configured to monitor only the portion of the electrical supply circuit excluding the EVSE, providing a direct measurement of the total current drawn by all other loads regardless of whether a PEV is charging. Once the current data has been received, the subprocess 240 may continue to block 260.

At block 260, a total current limit may be determined. The total current limit may represent the allowable total current drawn by the combination of the EVSE and all other subsidiary circuits of the electrical supply circuit. The total current limit may be equal to or less than the rated current or a trip current of the main breaker. The current limit may be lower than the rated current or a trip current of the main breaker so as to avoid tripping the main breaker or exceeding the rated current when the total current increases, such as when an appliance is activated on another subsidiary circuit. The difference in current between the calculated current limit and the rated current of the main breaker may be referred to as a current safety margin.

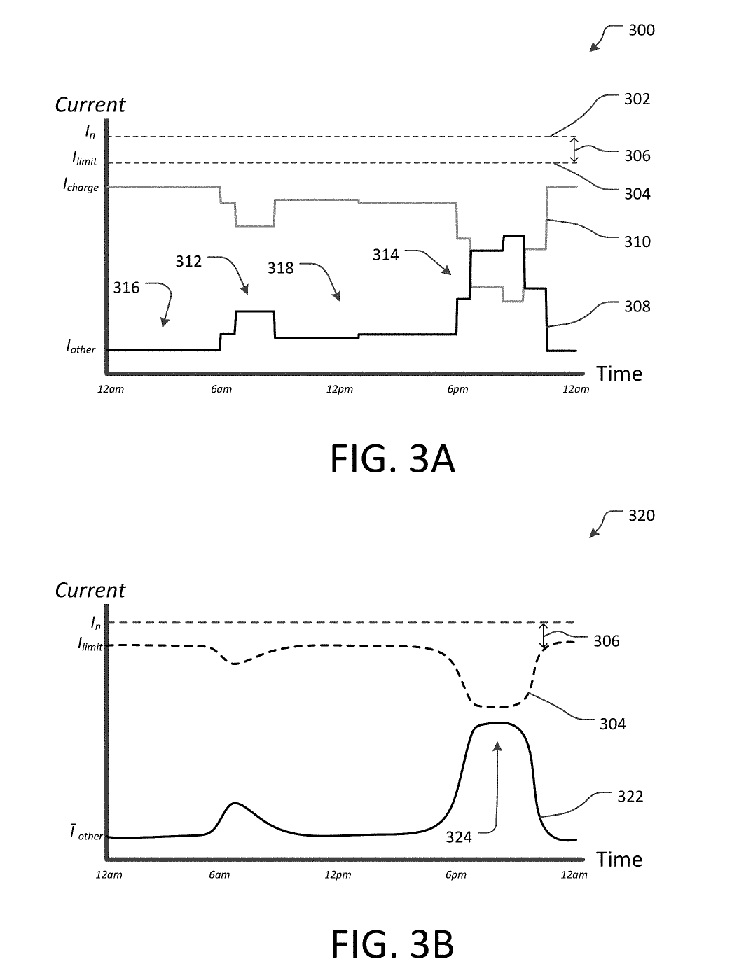

In some embodiments, the current safety margin and/or total current limit may be constant or substantially constant. For example, some adaptive charging systems may have a fixed current safety margin in the range of 5 Å, 10 Å, 20 Å, 30 Å, or more. In such embodiments, the EVSE can calculate a total current limit that is lower than the rated current of the main breaker by 5 Å, 10 Å, 20 Å, 30 Å, or more. In other embodiments, the current safety margin may be changeable over time. In some embodiments, the margin may be determined or changed based on analysis of past data collected locally at the EVSE. The current safety margin may also be determined or changed based on global data. In some embodiments, the current safety margin may be determined or changed based on settings or preferences received from a user such as by any type of user interface. For example, a home charging user may set a larger safety margin during times when the user is at home and awake, such as during the evening when the user is likely to use various electronic devices within the same electrical supply circuit. At the end of the evening, the user may set a lower current safety margin before going to bed, as the user is unlikely to turn on any additional electronic devices while sleeping. Methods for calculating current safety margins and allowable charging currents will be described in greater detail with reference to FIGS. 3A and 3B. When a current limit is calculated, the subprocess 240 may continue to block 270.

At block 270, the total current drawn by all other loads (as described above with reference to block 250) may be subtracted from the calculated current limit (as described above with reference to block 260) to calculate an allowable charging current. Allowable charging currents may in some cases be calculated without subtracting the present current from a total current limit. In some embodiments, a plurality of preset charging levels may be provided, with selection of charging levels based on a physical or software-implemented gate function. For example, where an electrical supply circuit having a 60A main breaker, the EVSE may be configured to allow charging at levels such as 15A, 30A, and 50A, each level having an associated current measurement threshold. Thus, processing circuitry of the EVSE may be configured to authorize charging at 15A if the detected current in the electrical supply circuit is less than 40 Å, 30 Å if the detected current is less than 25 Å, and 50 Å if the detected current is less than 5 Å. The allowable charging current may be transmitted to the PEV at block 230 as described above, and charging may begin.

FIG. 3A is a graph 300 depicting an example operation of an adaptive EVSE installed in a house over the course of an example weekday. The system may include a main breaker controlling the maximum current flow to the house. The main breaker may have a rated current, or nominal current Iₙ 302. The EVSE may have a calculated total current limit Iₗᵢₘᵢₜ 304. The total current Iₗᵢₘᵢₜ knit 304 may be less than Iₙ 302 by a current safety margin 306, as described herein. The graph 300 also includes the total current Iₒₜₕₑᵣ 308 drawn by all subsidiary circuits of the house other than the EVSE circuit, as well as the allowable charging current I_{charge} 310.

In the example EVSE operation depicted in FIG. 3A, the total current limit Iₗᵢₘᵢₜ 304 can be constant, separated from Iₙ 302 by a constant current safety margin 306. Throughout the day, the EVSE may monitor Iₒₜₕₑᵣ 308 in order to determine an appropriate allowable charging current I_{charge} 310. For example, the EVSE may monitor the total current draw at or near the main breaker using a current sensor as described herein, and may further monitor the current being drawn by a connected PEV, subtracting the current being drawn by the PEV (if connected) to determine Iₒₜₕₑᵣ 308. The EVSE may then calculate the allowable charging current I_{charge} 310 by subtracting Iₒₜₕₑᵣ 308 from Iₗᵢₘᵢₜ 304. In some embodiments, the EVSE may recalculate Iₒₜₕₑᵣ 308 repeatedly at regular intervals throughout the day, both while a PEV is connected and while a PEV is not connected. In other embodiments, the EVSE may only monitor Iₒₜₕₑᵣ 308 while a PEV is connected. In some embodiments, the EVSE may continuously monitor only the total current at the main breaker, recalculating Iₒₜₕₑᵣ 308 only upon the detection of a change in the total current.

The graph 300 shows the dependence of I_{charge} 310 on Iₒₜₕₑᵣ 308, which may generally interact according to the equation I_{charge}=Iₗᵢₘᵢₜ−Iₒₜₕₑᵣ. That is, changes in Iₒₜₕₑᵣ may result in a roughly equal but opposite change in I_{charge}. For example, Iₒₜₕₑᵣ 308 in the house represented in the graph 300 includes a morning increase 312 and an evening increase 314 corresponding to household appliance use. Increases 312 and 314 may occur due to residents using appliances such as a television, electric range, microwave oven, dishwasher, climate control, or other devices. Conversely, Iₒₜₕₑᵣ 308 may be relatively low during the night 316 while residents are sleeping and/or during the day 318 while residents are away such as at work, at school, or running errands. For each increase 312, 314 and decrease 316, 318 in Iₒₜₕₑᵣ 308, it can be seen that I_{charge} 310 experiences an equal but opposite change such that Iₗᵢₘᵢₜ 304 remains unchanged. In some implementations, changes in I_{charge} 310 may occur slight later than the corresponding changes in Iₒₜₕₑᵣ 308 due to the time required for processing circuitry of the EVSE to detect changes in Iₒₜₕₑᵣ 308 and recalculate the value of I_{charge} 310. When a change in I_{charge} 310 occurs while a PEV is connected, the EVSE may communicate the new I_{charge} to the PEV, which may adjust its charging current accordingly.

Referring now to FIG. 3B, in some embodiments the EVSE may be configured to adjust the current safety margin 306 and/or total current limit Iₗᵢₘᵢₜ 304 based on local or global electricity usage data, as depicted in graph 320. Locally collected current data may be used to determine or change a current safety margin in various ways. For example, the EVSE and current sensor may continuously monitor the amount of current used by all subsidiary circuits other than the subsidiary circuit containing the EVSE. The EVSE may then determine a daily average current profile Īₒₜₕₑᵣ 322 based on average values of Iₒₜₕₑᵣ at various times of day. For example, an EVSE may calculate an Īₒₜₕₑᵣ 322 profile for weekdays and a different Īₒₜₕₑᵣ 322 profile for weekends. In some embodiments, Īₒₜₕₑᵣ 322 may be calculated based on locally observed Iₒₜₕₑᵣ data stored for one day, multiple days, weeks, months, or longer. In some implementations, global data may be used in addition to or instead of locally collected data. For example, an EVSE may refer to data such as daily average household current use profiles for the country, state, province, region, county, city, or other area located around or near the location in which the EVSE is installed. In some embodiments, an EVSE may be preloaded with global data, or global data may be obtained such as by a connection to the internet. Some EVSE units may be configured to calculate total current limits initially based on global data and replace the global data with local data once a specified quantity of local data has been collected.

When the system has an Īₒₜₕₑᵣ 322 profile, it may calculate a total current limit Iₗᵢₘᵢₜ 304 based at least in part on the Īₒₜₕₑᵣ 322 profile. As shown in graph 320, the total current limit Iₗᵢₘᵢₜ 304 may be lower, and the current safety margin 306 may accordingly be larger, during times of day when average household current use Īₒₜₕₑᵣ 322 is relatively high, such as in the morning and in the evening. Similarly, the total current limit knit 304 may be higher, and the current safety margin 306 may accordingly be smaller, during times of day when average household current use Īₒₜₕₑᵣ 322 is relatively low, such as late at night and in the middle of the day. However, as shown at time 324, variations in Iₗᵢₘᵢₜ 304 and the current safety margin 306 may be smaller (e.g., of lesser magnitude) than the variations in Īₒₜₕₑᵣ 322. An increased current safety margin 306 at times of expected high usage may be advantageous by reducing the risk of the total current at the main breaker temporarily exceeding Iₙ, such as during the time delay between an increase in Iₒₜₕₑᵣ and the corresponding reduction in current drawn by a connected PEV, as described with reference to FIG. 3A.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

It will be appreciated by those skilled in the art that various modifications and changes may be made without departing from the scope of the described technology. Such modifications and changes are intended to fall within the scope of the embodiments, as defined by the appended claims. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged, or excluded from other embodiments.

Those of skill would further appreciate that any of the various illustrative schematic drawings described in connection with the aspects disclosed herein may be implemented as electronic hardware (e.g., a digital implementation, an analog implementation, or a combination of the two, which may be designed using source coding or some other technique), various forms of program or design code incorporating instructions, or combinations of both.

The various circuitry, controllers, microcontroller, or switches, and the like, that are disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both.

The functions described may be implemented in hardware, software, firmware, or any combination thereof. If implemented in software, the functions may be stored on or transmitted over as one or more instructions or code on a tangible, non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. A computer-readable medium may be in the form of a non-transitory or transitory computer-readable medium.

The term “determining” encompasses a wide variety of actions and, therefore, “determining” can include calculating, computing, processing, deriving, investigating, looking up (e.g., looking up in a table, a database, or another data structure), ascertaining, and the like. Also, “determining” can include receiving (e.g., receiving information), accessing (e.g., accessing data in a memory), and the like. Determining can also include resolving, selecting, choosing, establishing, and the like.

The above description is provided to enable any person skilled in the art to make or use embodiments within the scope of the appended claims. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An adaptive charging system for an electric vehicle comprising:
a charging station configured to draw current from an electrical supply circuit;
a current detector in communication with the charging station, the current detector configured to measure a current through the electrical supply circuit; and
processing circuitry configured to determine a charging current available to the vehicle at based at least in part on the current measured by the current detector.

2. The charging system of claim 1, further comprising communication circuitry configured to send information indicative of the available charging current to a vehicle coupled to the charging station.

3. The charging system of claim 1, wherein the current detector is further configured to measure the current through the electrical supply circuit repeatedly at regular intervals, and wherein the processing circuitry is further configured to determine the available charging current based at least in part on a plurality of current measurements.

4. The charging system of claim 2, wherein the communication circuitry is configured to send information indicative of at least two different available charging currents to the vehicle coupled to the charging station during a continuous charging session.

5. The electric vehicle charging station of claim 1, wherein the electrical supply circuit includes a main breaker having a rated current, and the maximum charging current available is less than the rated current.

6. The electric vehicle charging station of claim 5, wherein the maximum charging current available is offset from the rated current by a safety limit.

7. The electric vehicle charging station of claim 5, wherein the charging current available changes based at least in part on one or more currents measured by the current detector.

8. The electric vehicle charging station of claim 5, wherein the charging current available changes based at least in part on a time of day.

9. A method of charging one or more electric vehicle batteries with a charging station coupled to an electrical supply circuit, the method comprising:
monitoring current through the electrical supply circuit;
determining an amount of current available to the vehicle based at least in part on the monitored current; and
limiting charging current to the vehicle based at least in part on the amount of current available.

10. The method of claim 9, further comprising sending information indicative of the amount of current available to the vehicle.

11. The method of claim 9, wherein monitoring current includes monitoring with one or more current detectors.

12. The method of claim 9, wherein the amount of current available changes during a continuous charging session.

13. The method of claim 9, wherein the electrical supply circuit includes a main breaker having a rated current, and wherein the maximum amount of current available is less than the rated current.

14. The method of claim 13, wherein determining an amount of current available to the vehicle is based at least in part on the monitored current and the rated current.

15. The method of claim 14, wherein determining an amount of current available to the vehicle is based at least in part on the monitored current, the rated current, and a safety limit.

16. The method of claim 13, wherein the amount of current available to the vehicle is based at least in part on one or more previously monitored currents.

17. The method of claim 13, wherein the amount of current available to the vehicle is based at least in part on the time of day.

18. A method of charging one or more batteries of an electric vehicle, the method comprising:
providing a first charging current to a vehicle from a vehicle charging station connected to an electrical supply circuit;
monitoring the current drawn by the electrical supply circuit; and
adjusting the first charging current based at least in part on the monitored current.

19. The method of claim 18, wherein adjusting the first charging current comprises sending a signal indicative of an allowable charging current to the vehicle.

20. The method of claim 19, wherein the first charging current is adjusted in response to a change in the current drawn by the electrical supply circuit.
